(19) United States
(12) Patent Application Publication
(10) Pub. No.: US 2014/0195581 A1
(43) Pub. Date: Jul. 10, 2014

(54) FIXED POINT DIVISION CIRCUIT UTILIZING FLOATING POINT ARCHITECTURE

(71) Applicant: Paul S. WILKINS, Weston, MA (US)

(72) Inventor: Paul S. WILKINS, Weston, MA (US)

(73) Assignee: Analog Devices, Inc., Norwood, MA (US)

(21) Appl. No.: 13/736,677

(22) Filed: Jan. 8, 2013

(51) Int. Cl. G06F 7/535

(52) U.S. Cl. CPC G06F 7/535
USPC 708/653

(57) ABSTRACT

A system, method, and computer program product for dividing two binary numbers. The divider implements a fixed point division function using a floating point normalization architecture to yield the closest initial quotient approximation. The divider normalizes the input dividend and divisor to a range of [0.5, 1.0) by scaling each by necessary factors of two. The normalized inputs are submitted to a divider core that may be optimized for dividing inputs of such limited ranges. The divider core output is then rescaled by an appropriate factor of two, appropriately signed, and loaded into saturating registers for output in various formats. The divider core progressively outputs quotient bits in decreasing order of significance until a predetermined level of precision is reached, typically fewer bits than in a complete quotient, for faster output. One embodiment generates the six most significant quotient bits in one clock cycle.

### BACKGROUND

The present invention relates to a system, method, and computer program product for a divider that divides two numbers represented in binary form. The divider may be implemented in an integrated circuit.

Division is an arithmetic operation that may be regarded as the opposite of multiplication, and is required to solve many different problems. Conceptually, a quotient may be regarded as the number of times a dividend may fully contain a divisor. If a dividend is not evenly divided by a divisor, a remainder will be left over, and may be expressed in various ways. Thus generally, DIVIDEND=(QUOTIENT*DIVISOR)+REMAINDER. The sign of a quotient depends on the signs of the dividend and the divisor, i.e. the quotient is positive if the dividend and divisor have the same sign, but the quotient is negative if they have opposite signs. Division by zero is undefined.

The familiar manual operation of dividing of two numbers involves repeated subtraction of the divisor from the dividend. The quotient acts essentially as a counter of the number of times that the divisor may be fully subtracted from the dividend. Division of input numbers may stop when the remainder is less than the divisor, but more generally the process may continue to evaluate the remainder as a fractional number.

Division of numbers represented in binary form is also required for a variety of purposes. For example, digital computers have microprocessors that perform binary division, among other operations, in their arithmetic logic units. Digital signal processing circuitry often requires binary division as well. Conventional binary dividers follow the familiar ‘repeated subtraction’ algorithm, and as a result have a number of disadvantages, chiefly that their operation may be very time-consuming.

Accordingly, the inventor has identified a need in the art for an improved binary divider.

### BRIEF DESCRIPTION OF THE DRAWINGS

FIG. 1 is a diagram depicting an exemplary fast divider schematic according to one aspect of the present invention.

FIG. 2 is a flowchart depicting an exemplary fast divider methodology according to one aspect of the present invention.

FIG. 3 is a diagram depicting an exemplary divider core schematic according to one aspect of the present invention.

FIG. 4 is a diagram depicting an exemplary multiple-format full divider schematic according to one aspect of the present invention.

### DETAILED DESCRIPTION

Embodiments of the invention provide a system, method, and computer program product for dividing two binary numbers. In some instances, a full quotient may not need to be computed at all, as a partial quotient may be sufficient for some purposes. Fast production of a partial quotient may be of particular utility in certain applications, such as digital signal processing.

A fast divider embodiment is therefore provided that may rapidly calculate a partial quotient that is only an approximation of the full quotient value. For example, only 24 bits of a full 64-bit quotient may be calculated, but those 24 bits are the most significant ones. Such an embodiment may provide a fast result of limited accuracy, yet with a large dynamic range. An alternate embodiment is also described that provides a full quotient in a variety of binary formats.

As will be described below, the fast divider may implement a fixed point division function by using a floating point normalization architecture to yield the closest initial quotient approximation. Briefly, the fast divider may normalize its inputs, perform a 24-bit divide operation, and multiply/shift the output to its correct value. Normalizing the inputs allows a divider core to be highly optimized, since the inputs it handles may be constrained to the range of [0.5, 1.0), i.e. from one-half, inclusive, up to nearly one.

Further, the desired-precision quotient may be computed by a divider core that outputs results in chunks or quotient subsets. Rapid generation of even an initial chunk of a partial quotient may be of great utility in some circumstances. The divider embodiments described may therefore rapidly produce the most significant bits of a quotient subset, and then proceed to generate additional quotient bits of lower significance over further clock cycles until a predetermined quotient precision is reached.

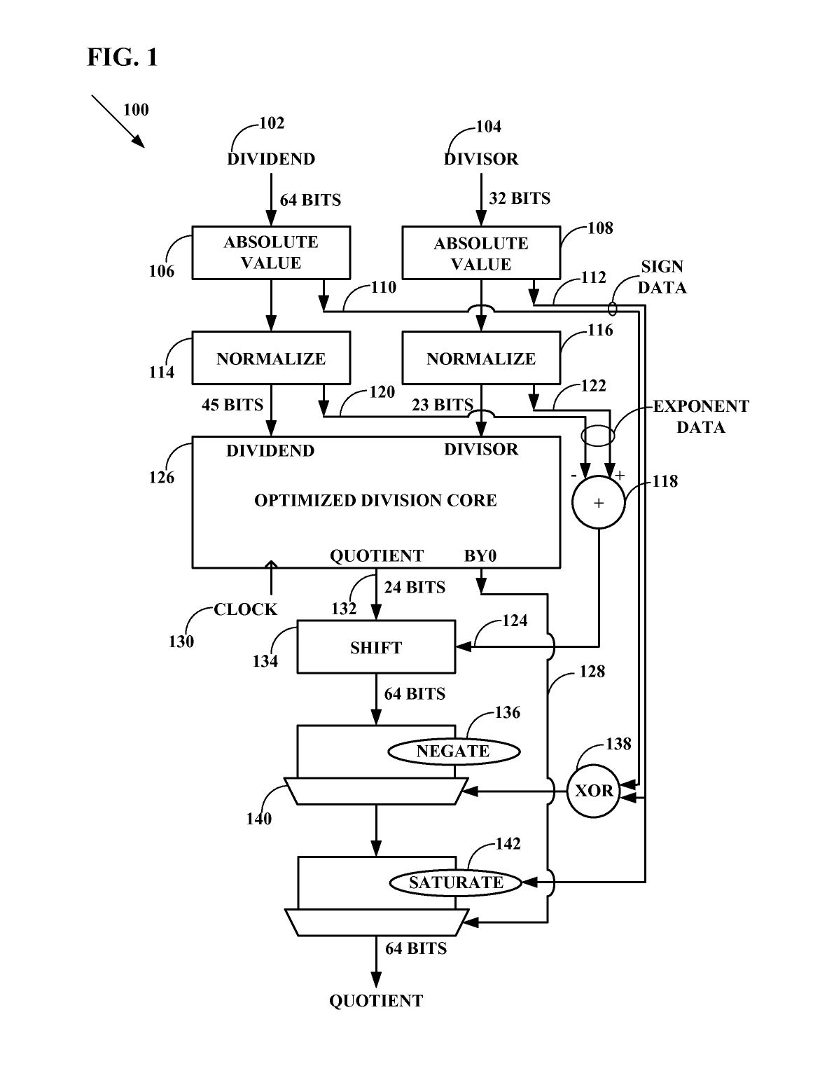

FIG. 1 is a functional diagram depicting an exemplary fast divider 100 according to one aspect of the present invention. Fast divider 100 may be fabricated as an integrated circuit. Dividend 102 and divisor 104 are the inputs to the fast divider. In one exemplary embodiment, the dividend may be a 64-bit binary number and the divisor may be a 32-bit binary number. Submission of the divisor to the fast divider 100 may trigger the fast divider's operation in one embodiment.

Dividend 102 and divisor 104 may be signed numbers in one embodiment, so the fast divider 100 may next take the absolute value of each input at blocks 106 and 108, and split out a dividend sign bit 110 and a divisor sign bit 112 for subsequent use. The sign bits 110 and 112 may determine the appropriate sign of the quotient, to be described.

The fast divider 100 may include blocks 114 and 116 to normalize the now-unsigned dividend 102 and divisor 104 respectively, so that each number may have a value within a range of [0.5, 1.0), i.e. one-half, inclusive, up to but not including one. In one embodiment, the inputs may be normalized by scaling each number by a necessary factor of two until a most significant bit position of each number is a “1”. Binary numbers may be easily changed in value by a factor of two by shifting digits one bit. Circuit blocks 114 and 116 may thus shift dividend 102 and divisor 104 as needed so the scaled value of each lies within the desired range. Data describing exponents obtained therefrom may be passed to an adder 118. The adder 118 may subtract the exponents (e.g., powers of two) that were utilized in each normalization (e.g., scaling factor 120 for dividend 102 from the scaling factor 122 for divisor 104) to yield a quotient rescaling factor 124, to be described.

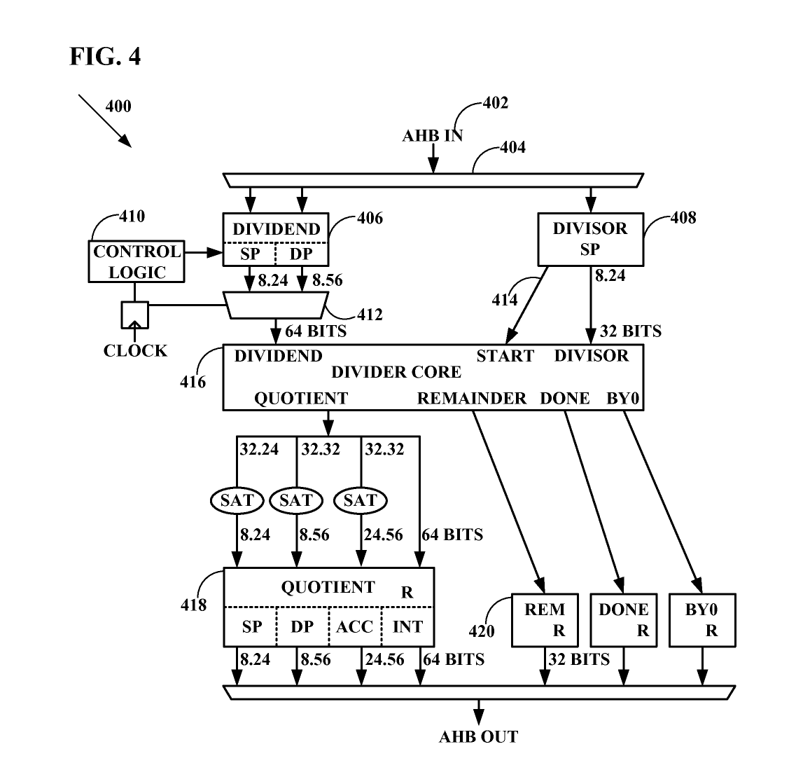

In one embodiment, the normalized dividend may be a 45-bit number, while the normalized divisor may be a 23-bit number. The normalized inputs may be submitted to a divider core 126 that performs division. Different embodiments of divider core 126 are described below in reference to FIG. 4. Different embodiments may have different divisor widths and different throughputs (e.g., calculated quotient bits) per clock cycle. A divide-by-zero flag BY0, 128, may be generated by the divider core; division by zero is undefined and may be treated as an error condition that may halt operation and trigger output of a particular predetermined quotient value. In one embodiment, divider core 126 may begin its operation upon receipt of a clock signal 130, which may be an Advanced High-Performance Bus (AHB) clock signal. AHB is part of the Advanced Microcontroller Bus Architecture (AMBA) protocol, an open standard on-chip interconnect specification well known in the art of microcontroller design.

The output 132 of divider core 126 is a quotient of the normalized dividend and normalized divisor. In one embodiment, the output of the system may be a 24-bit number representing a quotient of the normalized inputs. The quotient may be retrieved from a storage unit within the divider core 126 that stores the quotient. In other embodiments, the divider core output 132 may be established over multiple clock cycles of operation, wherein a predetermined number or “chunk” of the overall number of desired quotient bits may be calculated per clock cycle.

As will be described, a first chunk of the quotient bits to be calculated may be generated by the divider core 126 quite rapidly, e.g. within one bus clock cycle. This subset of the quotient bits may comprise the most significant quotient bits, so that a most accurate approximation of the quotient may be produced as an initial output. Additional bits of less significance may be generated later, a process that may continue until a desired level of quotient precision is achieved. The divider core 126 thus may be designed to meet particular needs by progressively outputting quotient bits in decreasing order of significance. In a system that calculates six quotient bits per clock cycle for example, the six most significant bits would be available after one clock cycle, the twelve most significant bits after two clock cycles and so on. All twenty-four exemplary quotient bits would be available after four clock cycles.

The output 132 of divider core 126 may be scaled by quotient rescaling factor 124 to compensate for any prior input scaling during normalization. As with the normalizing circuits previously defined, a shift register 134 may scale the divider core output by powers of two, by shifting the output an appropriate number of bits in the appropriate direction. In one embodiment, the scaled output may be a 64-bit number.

The scaled output may be converted to a signed number as necessary by signer 136 based on the dividend sign bit 110 and the divisor sign bit 112. In one embodiment, logic 138 performs an exclusive-OR operation on the dividend sign bit 110 and the divisor sign bit 112 to determine the quotient sign, e.g., if only one of the dividend and divisor are negative then the quotient should be negative, otherwise it is positive. The signed scaled output may be stored in a register 140.

The signed scaled output may also be loaded into a saturating accumulator 142 for output as the quotient. Saturating arithmetic limits or “clamps” the values of processed numbers to maximum or minimum range limits during arithmetic operations. This behavior may avoid the often unrealistically drastic changes in numerical value that may result from modular arithmetic “wrap around”. For example, in an 8 bit register, 256 numerical values are available to describe a physical measurement that normally ranges from zero to 255 at most. If the measurement exceeds the expected range, the register may for example “roll over” to zero during overflow, producing a highly misleading numerical description because the true most significant bit is discarded. Similar problems may occur with underflow and the storage of negative numerical values. Saturating accumulator 142 therefore may effectively reformat the signed scaled output to best represent the quotient value with the available register size. The use of saturating accumulators is optional.

FIG. 1 represents a functional block diagram that may have circuits devoted to each block. Circuits may be merged as desired, such as for speed and power efficiency. Some functions may be performed by controllers, as may be known in the art.

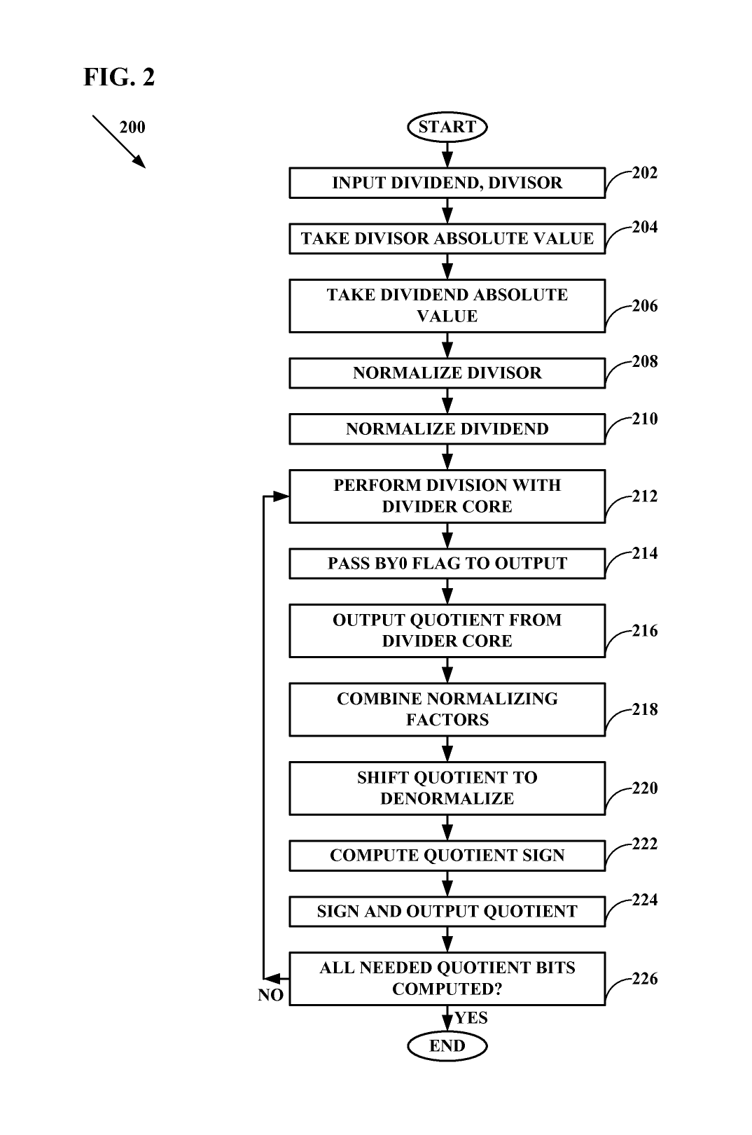

Referring now to FIG. 2, a flowchart depicting an exemplary fast divider methodology 200 is shown according to one aspect of the present invention. The dividend and divisor may be input at step 202. These inputs may occur in separate steps, and the input of the divisor may trigger the methodology to begin in some embodiments.

In step 204, the absolute value of the divisor may be taken, with sign information retained for later use in computing the quotient sign. In step 206, the absolute value of the dividend may be taken, with divisor sign information similarly retained. Sign processing may be performed simultaneously in some embodiments.

The divisor may be normalized in step 208, which may comprise bit-shifting the divisor by a sufficient power of two so that its scaled value is in the range of [0.5, 1.0), i.e. from one half, inclusive, up to but not actually including one. Similarly, the dividend may be normalized in step 210; the normalizing of divisor and dividend need not occur in the exemplary order described, and indeed may be performed simultaneously.

In step 212, the divider core may begin performing division of the processed dividend and divisor. The divider core may generate a divide-by-zero flag in step 214, which may trigger special handling of the output to denote an error condition. For example, the divider 200 may output a particular final value to denote the divide-by-zero error condition. The divider core may otherwise generate a quotient or quotient chunk in step 216.

In step 218, the method may combine the dividend and divisor normalizing factors to generate a rescaling or denormalizing factor to be applied to the quotient. In step 220, the quotient may be scaled for example by an appropriate power of two by bit-shifting. In step 222, the sign of the quotient may be calculated from the sign of the divisor and the sign of the dividend, e.g. different signs will yield a negative quotient. In step 224, the quotient (or quotient “chunk”, e.g., progressively generated quotient subset) with proper sign may be output.

In step 226, the method may determine if all required quotient bits have been calculated. In one embodiment, a first subset of the quotient bits to be calculated may be generated within one bus clock cycle; these may be the most significant quotient bits. Additional required bits, generally of less significance, may be generated as the method may selectively return operation to the divider core to perform additional computations in step 226. This computation process may continue until a desired level of output quotient precision is achieved.

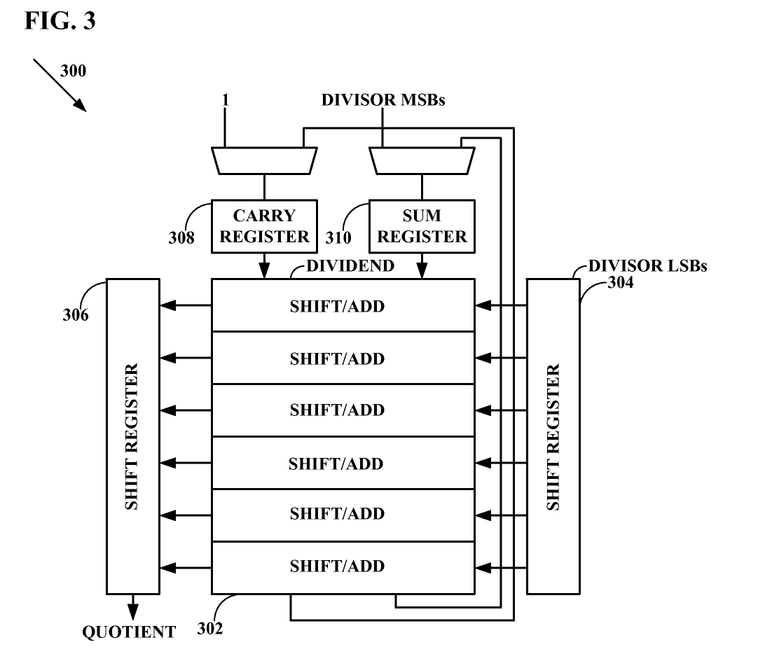

Referring now to FIG. 3, a diagram depicting an exemplary divider core schematic is shown according to one aspect of the present invention. This divider core 300 may be used with the fast divider embodiment previously described, or with an alternative divider embodiment to be described regarding FIG. 4. Other divider cores as may be known in the art may also be employed, such as the iterative array divider (IAD) circuit described in “An Augmented Iterative Array for High-Speed Binary Division” by Maurus Cappa and V. Carl Hamacher in IEEE Transactions on Computers, v. C-22, n. 2, February 1973, which is hereby incorporated by reference in its entirety.

Divider core 300 may comprise a number of shift/add blocks 302. Each shift/add block 302 may perform this operation:

```
if(carry_in == 1){
    {carry_out, sum_out} = sum_in * 2 + dividend_bit + divisor;
} else {
    {carry_out, sum_out} = sum_in * 2 + dividend_bit − divisor;
}
```

Each shift/add block 302 thus calculates an output carry bit carry_out and an outut sum bit sum_out. The carry_out and sum_out bits are calculated from an input carry bit carry_in, an input sum bit sum_in, a dividend bit, and the divisor. If the carry_in bit is equal to one, then the divisor is added to the dividend bit and twice the sum_in bit. Otherwise, if the carry_in bit is equal to zero, then the divisor is subtracted from the dividend bit and twice the sum_in bit.

The carry_out bit from a shift/add block 302 may represent a quotient bit. Thus 64 shift/add blocks would be required for processing a 64-bit quotient in a single circuit. In one exemplary implementation only six shift/add blocks can complete their operation within one clock cycle. Therefore, in that embodiment divider core 300 comprises a sequential machine built with a set of six shift/add blocks 302 as shown, to produce a chunk of six quotient bits during a clock cycle, and registers 308 and 310 for holding the final carry and sum values from the end of each pass.

At the beginning of every subsequent clock period, the previous final carry and sum values may be fed back into the set of shift/add blocks 302 so a further chunk of six more quotient bits may be computed. The correct dividend bits and quotient bits may be sequenced through shift registers 304 and 306. The registers may all be controlled from a simple state machine (not shown).

Referring now to FIG. 4, a diagram depicting an exemplary multiple-format full divider schematic is shown according to one aspect of the present invention. This embodiment is similar to the fast divider embodiment discussed above, but requires more clock cycles to compute the full quotient versus a mere approximation of the correct full quotient value. The six bit per clock cycle shift/add architecture divider core of FIG. 3 may be employed with this divider.

Input bus signals 402 may be processed by a decoder 404 to yield a dividend and divisor, each stored in registers 406 and 408 respectively. The AHB is an exemplary type of bus, though others as may be known in the art are also applicable. The mode of full divider 400 may be selected by control logic 410 according to the order in which its registers are written to, e.g. the most recently written to dividend register may determine what data is used for the dividend 412. Similarly, writing to divisor register 408 may trigger a start signal 414 to direct divider core 416 to begin its operations.

Divider core 416 may process the dividend and divisor and yield a quotient as well as a remainder, a division completed signal, and a possible divide-by-zero error signal. The divider core exemplary inputs and outputs, corresponding register names, and data formats may be summarized by the following table:

| NAME | FUNCTION | ADDRESS | WIDTH | ACCESS |
|---|---|---|---|---|
| DIV_DIVIDEND_DP | DOUBLE PRECISION | 0 | 8.56 | R/W |
| | DIVIDEND FOR FIXED POINT | | | |
| | DIVISION | | | |
| DIV_DIVIDEND_SP | SINGLE PRECISION DIVIDEND | 4 | 8.24 | R/W |
| | FOR FIXED POINT DIVISION | | | |
| DIV_DIVISOR_SP | SINGLE PRECISION DIVISOR | 5 | 8.24 | R/W |
| DIV_REMAINDER | INTEGER REMAINDER | 18 | 32 | R |
| DIV_QUOTIENT_SP | SATURATED SINGLE | 7 | 8.24 | R |
| | PRECISION QUOTIENT | | | |
| DIV_QUOTIENT_INT | INTEGER QUOTIENT | 8 | 64 | R |
| DIV_QUOTIENT_DP | SATURATED DOUBLE | 10 | 8.56 | R |
| | PRECISION QUOTIENT | | | |
| DIV_QUOTIENT_ACC | SATURATED ACCUMULATOR | 12 | 23.56 | R |
| | PRECISION QUOTIENT | | | |
| DIV_DONE | DIVISION COMPLETE | 17 | 1 | R |
| DIV_BY0 | DIVISION BY ZERO | 16 | 1 | R |
| | OCCURRED | | | |

The multiple-format full divider 400 may operate in fixed point division modes or in an integer division mode. In the fixed point mode, the full divider may support the division of either two single precision (SP) numbers, or the division of a double precision (DP) number by a single precision number, with the results being placed in an extended double precision register (ACC).

### Fixed Point Division:

When performing single precision division, full divider 400 may support the following format operations, where x·y denotes the number of bits x before the binary point and the number of bits y after the binary point:

8.24=8.24/8.24

8.56=8.24/8.24

24.56=8.24/8.24

When performing double precision division, full divider 400 may support the following format operations:

8.24=8.56/8.24

8.56=8.56/8.24

24.56=8.56/8.24

Performing an 8.24/8.24 division will potentially result in a 33.28 number. The resulting number may thus be mapped into a saturating accumulator (24.56), a saturated double precision register format (8.56) and a saturated single precision register format (8.24). In the single precision register any extra fractional bits may be truncated.

Performing an 8.56/8.24 division will potentially result in a 33.28 number. As with the case of dividing two single precision numbers, the resulting number may be thus mapped into a saturating accumulator (24.56), a saturated double precision register (8.56) and a saturated single precision register format (8.24). In the single precision register any extra fractional bits may again be truncated. In fixed point mode, there may be a remainder.

### Integer Division:

In integer division mode, full divider 400 may support the division of a signed 64-bit number with a signed 32-bit number. The result may be a 64-bit number. In integer node, there will be a 32-bit remainder.

### Usage and Divide-by-Zero Management:

The full divider may be configured as a signed divider. The different modes of the full divider may be mapped as a number of virtual registers that sit on top of a smaller number of real registers.

In the case of a division by zero, the result may be a saturated output quotient of plus or minus a maximum numerical value, with a remainder of zero. In integer mode, such an output may be one of 2⁶³-1 and −2⁶³. In fixed point mode, such a saturated output may be plus or minus the maximum value of an 8.56 or a 24.56 formatted number.

The quotient register 418 and remainder register 420 may only be updated when the full divider reports that it has completed its operations. The most recently written dividend data may be retained after a division is complete, so that if the dividend data has not changed the user need not re-write the dividend for the next division operation.

While particular embodiments of the present invention have been described, it is to be understood that various different modifications within the scope and spirit of the invention are possible. The invention is limited only by the scope of the appended claims.

As described above, one aspect of the present invention relates to a fast binary divider. The provided description is presented to enable any person skilled in the art to make and use the invention. For purposes of explanation, specific nomenclature is set forth to provide a thorough understanding of the present invention. Description of specific applications and methods are provided only as examples. Various modifications to the preferred embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described with reference to operations that may be performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

What is claimed is:

1. A circuit for dividing two input binary numbers, comprising:
a normalizer for normalizing an input divisor and an input dividend;
a divider core for dividing the normalized inputs to produce an at least partial quotient;
a scaler for reversing the normalizing; and
at least one output register for outputting the at least partial quotient.

2. The circuit of claim 1 wherein the circuit communicates via an Advanced High-Performance Bus (AHB).

3. The circuit of claim 1 wherein the circuit is triggered by receipt of the divisor.

4. The circuit of claim 1 wherein the circuit outputs at least one of a divide-by-zero flag and a predetermined quotient value when a divide-by-zero event occurs.

5. The circuit of claim 1 wherein the particular register written with the dividend determines at least one of an operating mode and a data format.

6. The circuit of claim 1 wherein the normalizer shifts divisor bits and dividend bits, and the scaler compares the shifts of the dividend and of the divisor and shifts the quotient bits accordingly.

7. The circuit of claim 1 wherein the normalizer normalizes the divisor and the dividend to each be within the range of [0.5, 1.0).

8. The circuit of claim 1 wherein the circuit computes at least one of a full quotient and a partial quotient.

9. The circuit of claim 8 wherein the full quotient comprises 64 bits and the partial quotient comprises 24 bits.

10. The circuit of claim 1 wherein the divider core is optimized for dividing normalized inputs.

11. The circuit of claim 1 wherein the divider core computes quotient chunks in decreasing bit significance order.

12. The circuit of claim 1 wherein the divider core computes a plurality of quotient chunk bits per bus clock cycle.

13. The circuit of claim 1 wherein the divider core computes quotient chunks until a predefined quotient precision level is reached.

14. The circuit of claim 13 wherein the quotient chunks comprise six bits.

15. The circuit of claim 1 wherein the divider core comprises a Cappa integrated array divider (IAD).

16. The circuit of claim 1 wherein the divider core comprises shift registers that sequence in at least one divisor bit and sequence out at least one quotient bit through at least one shift/add block,
wherein the first shift/add block initially holds the dividend,
wherein each shift/add block computes an output carry bit and an output sum bit, each being twice an input sum bit, plus a dividend bit, plus a divisor bit signed according to an input carry bit value,
wherein the quotient bit is the output carry bit, and
wherein the output carry bit and the output sum bit are at least one of: passed to a subsequent shift/add block and recycled to the first shift/add block, for computing another quotient bit.

17. The circuit of claim 1 wherein the circuit further comprises a sign corrector that computes a quotient sign bit from an exclusive-OR of a dividend sign bit and a divisor sign bit.

18. The circuit of claim 1 wherein the output register is a saturating accumulator.

19. A method of dividing two input binary numbers, comprising:
normalizing a divisor and a dividend;
dividing the normalized inputs to produce an at least partial quotient;
reversing the normalizing; and
outputting the at least partial quotient.

20. The method of claim 19 wherein the normalizing scales the divisor and the dividend to each be within the range of [0.5, 1.0).

21. The method of claim 19 wherein the dividing progressively yields quotient chunks in decreasing bit significance order until a predefined quotient precision level is reached.

22. A system for dividing two input binary numbers, comprising:
means for normalizing a divisor and a dividend;
means for dividing the normalized inputs to produce an at least partial quotient;
means for reversing the normalizing; and
means for outputting the at least partial quotient.

23. The system of claim 22 wherein the means for normalizing scales the divisor and the dividend to each be within the range of [0.5, 1.0).

24. The system of claim 22 wherein the means for dividing progressively yields quotient chunks in decreasing bit significance order until a predefined quotient precision level is reached.
